(19) United States
(12) Patent Application Publication
(10) Pub. No.: US 2013/0090223 A1
(43) Pub. Date: Apr. 11, 2013

(54) TOOL-HOLDER MODULE FOR SHAPING AT LEAST ONE CARDBOARD CUT-OUT

(71) Applicants: Michel Begin, Octeville Sur Mer (FR); Philippe Chevalier, Octeville Sur Mer (FR); Thierry Garnier, Octeville Sur Mer (FR); Pierre Variot, Octeville Sur Mer (FR); Frederic Roca, Octeville Sur Mer (FR); Jerome Sergent, Octeville Sur Mer (FR)

(72) Inventors: Michel Begin, Octeville Sur Mer (FR); Philippe Chevalier, Octeville Sur Mer (FR); Thierry Garnier, Octeville Sur Mer (FR); Pierre Variot, Octeville Sur Mer (FR); Frederic Roca, Octeville Sur Mer (FR); Jerome Sergent, Octeville Sur Mer (FR)

(73) Assignee: SIDEL PARTICIPATIONS, Octeville Sur Mer (FR)

(21) Appl. No.: 13/703,665

(22) PCT Filed: Jun. 16, 2011
(86) PCT No.: PCT/FR11/51376

§ 371 Date: Dec. 12, 2012

(30) Foreign Application Priority Data
Jun. 18, 2010 (FR) 10 54868

(51) Int. Cl. B31B 3/26; B31B 1/26; B31B 3/02; B31B 1/04

(52) U.S. Cl. CPC B31B 3/26; B31B 1/04; B31B 1/26; B31B 3/02
USPC 493/180; 493/422; 493/331; 493/468; 493/473

(57) ABSTRACT

A method for shaping at least one cardboard cut-out between an inlet position and an outlet position of a shaping station. The method includes a step of using shaping tools on the cardboard cut-out, the tools reciprocatingly moving on either side of the cut-out between a shaping position and a retracted position. The method involves moving the cardboard cut-out by the tools between the inlet position and the outlet position of the shaping station while the cardboard cut-out is being shaped by the tools.

The invention relates to a tool-holder module for shaping at least one cardboard blank (also referred to herein as a “cut-out”), in order to create a packaging item.

“Packaging item” is understood to mean cardboard boxes, display boxes in the form of a tray with turned-down edges, top caps for product batches, boxes with lids having flaps, etc.

Methods and systems are known for shaping cardboard blanks in an industrial facility in order to create such packaging items. These items are usually created at speeds which can reach 25 items per minute.

For example, in the domain of packaging elements or various containers shaped from cardboard blanks, installations are known which comprise a station equipped with a die and a punch arranged on each side of a belt that supplies the cardboard blanks. The blanks are arranged facing the die, and the item to be shaped is made by punching the blank, meaning the die applies pressure on one side of the cardboard blank while the punch presses against the other side of the blank at the same time. Document DE 200 19 140 describes an example of such a shaping system.

The invention arises from a desire to create an installation capable of higher speeds than existing machines. In other words, the desire was to achieve speeds of greater than 25 items per minute.

There was also a desire to create a machine that adapts to shaping various items, for example cardboard display trays, as well as to closing boxes for example.

The invention achieves these goals and it firstly relates to a method for shaping at least one cardboard blank between an entry position and an exit position of a shaping station, said method including a step of using shaping tools on said cardboard blank, said tools moving reciprocatingly on each side of said blank between a shaping position and a retracted position,

said method consisting of ensuring the movement of the cardboard blank by means of said shaping tools between said entry position and said exit position of the shaping station while the cardboard blank is being shaped by said shaping tools. Such a method is described in document DE 198 43 490 in particular.

In the invention, a noteworthy aspect of the method is that within said shaping station, it makes use of at least two tool-holder modules, each tool-holder module comprising at least one shaping trolley carrying a die and a punch which constitute the shaping tools, each shaping trolley of each module taking turns being in charge of the cardboard blanks arriving at the entry position of said shaping station.

The fact that each shaping trolley comprises a die (whole—not in two parts) and a punch offers several advantages: the amount of equipment used is reduced (only two modules) while providing higher speeds. The dimensions of the machine for carrying out the method are also smaller than those of the machine presented in document DE 198 43 490.

The method of the invention also comprises the following characteristics, separately or combined:
the shaping trolleys of said at least two modules take turns, at regular intervals, at being in charge of the blanks;
the method comprises a step of applying glue to at least a portion of a cardboard blank before the cardboard blank is shaped.

The invention also relates to applying the method as defined above in order to create cardboard displays, cardboard boxes, or batches of items. The invention also relates applying the method to the closing of boxes.

In addition, the invention concerns a tool-holder module for shaping at least one cardboard blank in a shaping station, in order to implement the method as defined above, said tool-holder module comprising:
at least one set of shaping tools;
means for moving each of the tools on each side of a cardboard blank, between a shaping position and a retracted position;
means for applying pressure by at least one of the tools against a face of the blank.

The module of the invention is noteworthy in that it comprises a shaping trolley carrying the tools, its set of tools including a die and a punch. To achieve its purpose, the module comprises means for moving the shaping trolley between an entry position where the blank enters the shaping station and an exit position where the shaped blank leaves the shaping station.

The module of the invention may also comprise the following characteristics, separately or in combination:
the shaping trolley is mounted on runners and the means for moving the trolley comprise a belt, connected to the shaping trolley, and an actuator able to drive the belt in one direction and in the reverse direction:
the means for moving the tools between the shaping position and the retracted position are carried by the shaping trolley and comprise:
   i. at least one runner on which tool holders are movably mounted, each of the tools being mounted on a tool holder and each of the tool holders being connected to a belt, and
   ii. an actuator to drive each belt in one direction and in the reverse direction.
each of the tools is removably mounted on the tool holder to which it is connected;
the tools comprise a die consisting of a central plate and at least one hinged flap, for performing a capping and/or folding operation;
the module comprises holding means for maintaining a blank in place after shaping and before retraction of the shaping tools;
the holding means comprise a device equipped with a plate having suction cups able to hold a bottom of a shaped blank in place with suction, the device being movably mounted to travel between a position where it holds the blank in place before retraction of the shaping tools and a position where it is retracted to allow removal of the blank;
at least one of the shaping tools comprises means for accommodating and accepting the holding means;
it comprises means for moving at least one of the shaping tools transverse to a direction of movement of the blanks during their shaping.

Lastly, the invention relates to an installation equipped with a tool-holder module as defined above. It may comprise means for bringing blanks to the entry position of the shaping station and means for taking charge of the shaped blanks at the exit position where they leave the shaping station.

The invention is described below in a sufficiently clear and complete manner to enable its execution, accompanied by drawings in which:

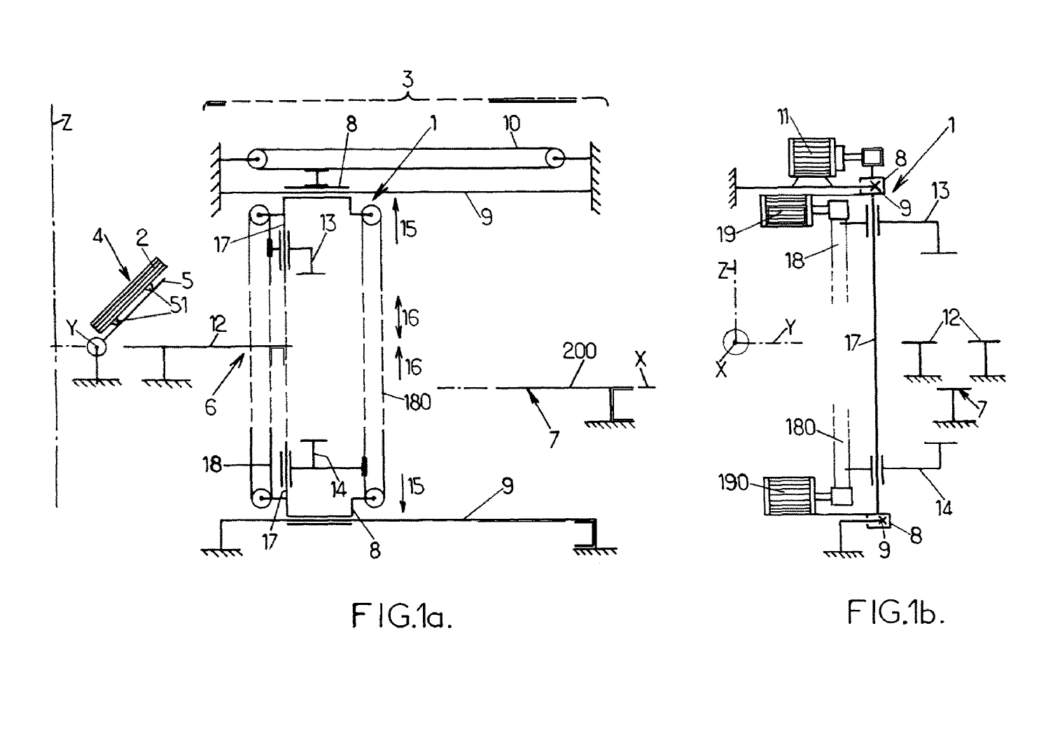

FIG. 1a is a schematic representation of a front view of an installation equipped with a tool-holder module of the invention, in which the tools are positioned according to a first shaping step of the method according to the invention;

FIG. 1b is a side view of the installation shown in FIG. 1a;

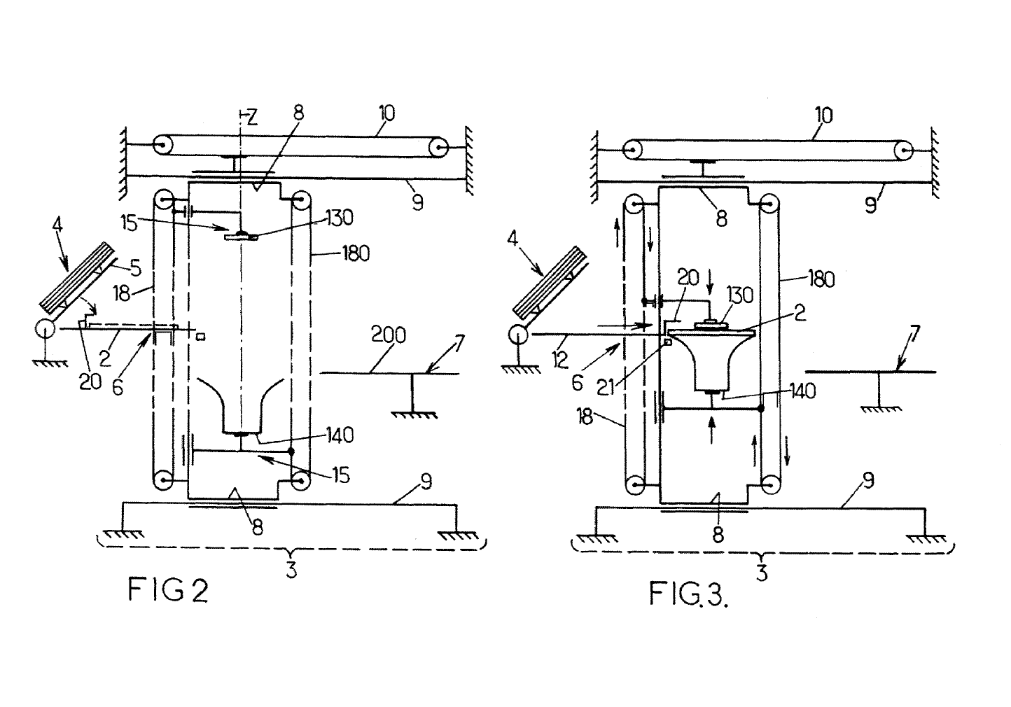

FIG. 2 illustrates a module of the invention in which the tools are a punch and a die resembling a bell, and are positioned according to a first shaping step of the invention;

FIG. 3 illustrates the position of the die and punch shown in FIG. 2, during a second step of the method of the invention;

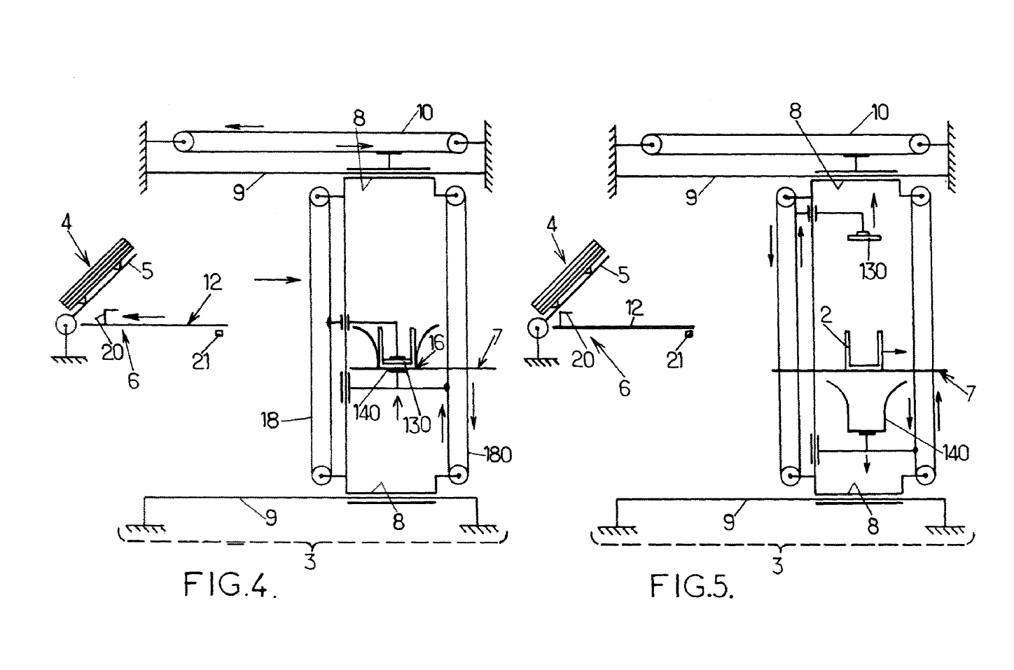

FIG. 4 illustrates the position of the die and punch shown in FIGS. 2 and 3, during a third step of the method of the invention;

FIG. 5 illustrates the position of the die and punch shown in FIGS. 2, 3 and 4, during a fourth step of the method of the invention;

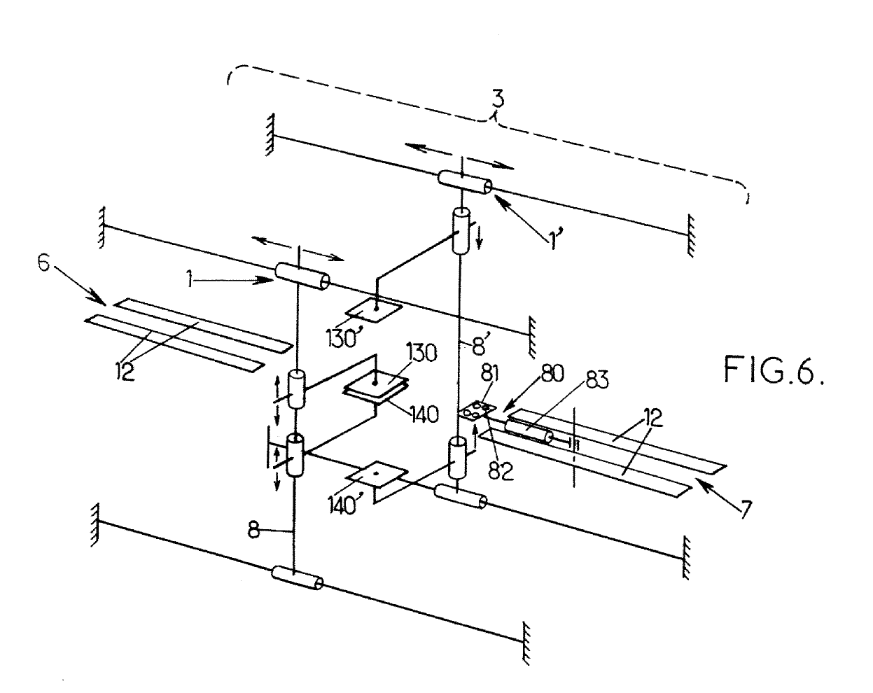

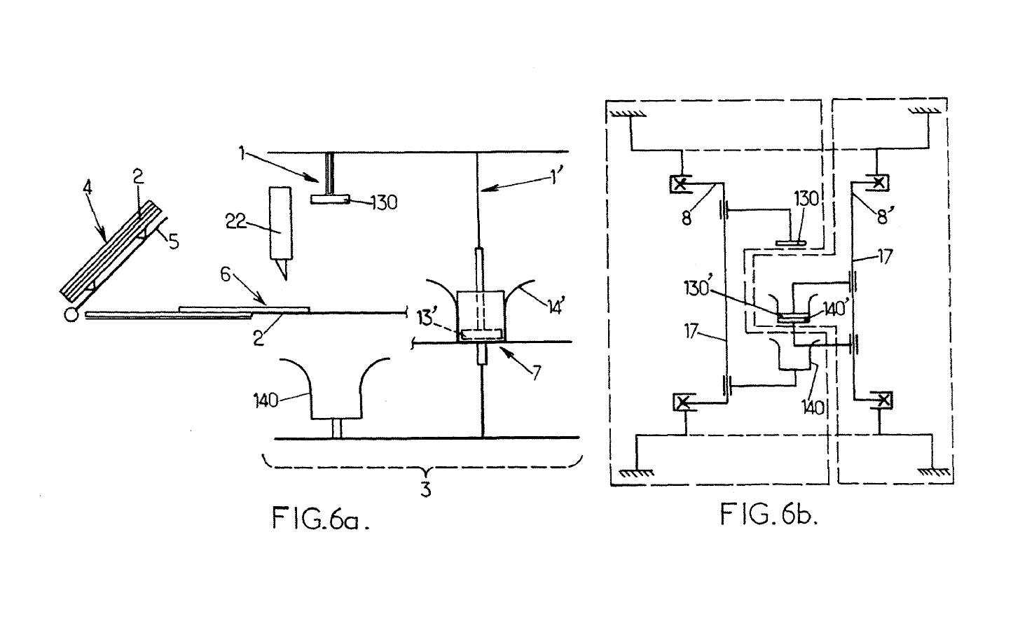

FIG. 6 is a perspective schematic view of an installation equipped with two tool-holder modules according to the invention;

FIG. 6a is a schematic representation of a front view of the installation shown in FIG. 6, during a first step of the method of the invention;

FIG. 6b is a side view of the installation shown in FIG. 6a;

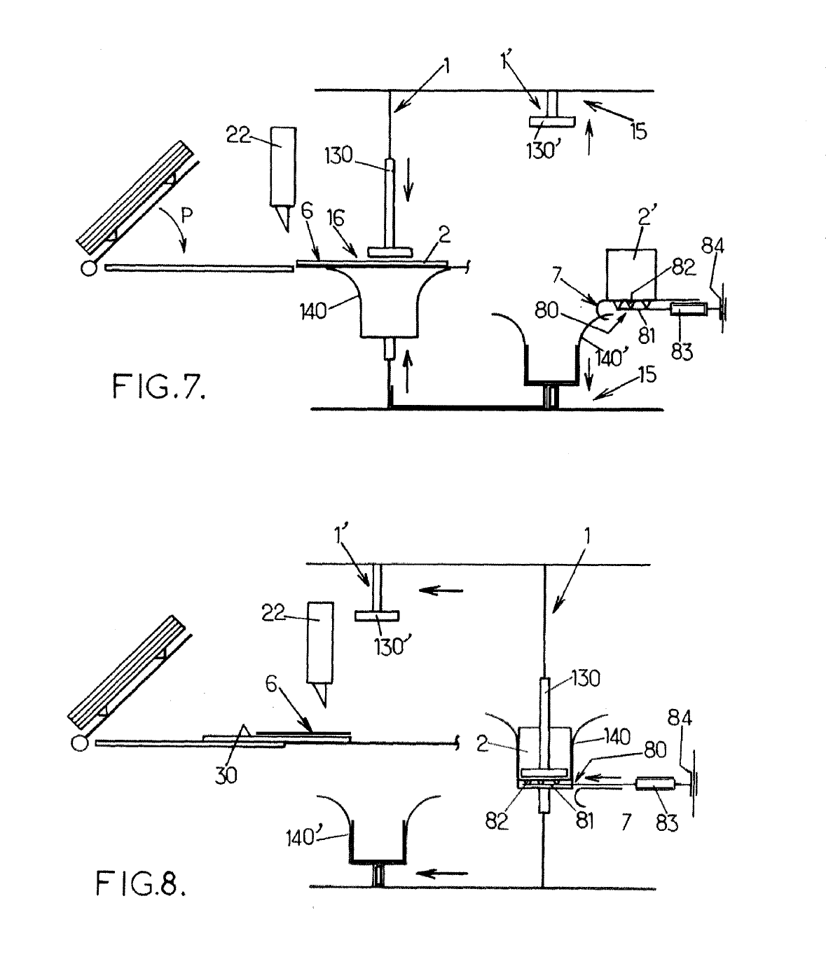

FIG. 7 illustrates the position of the tools of the two modules shown in FIGS. 6a and 6b, during a second step of the method according to the invention;

FIG. 8 illustrates the position of the tools of the two modules shown in FIGS. 6a and 6b, during a third step of the method of the invention;

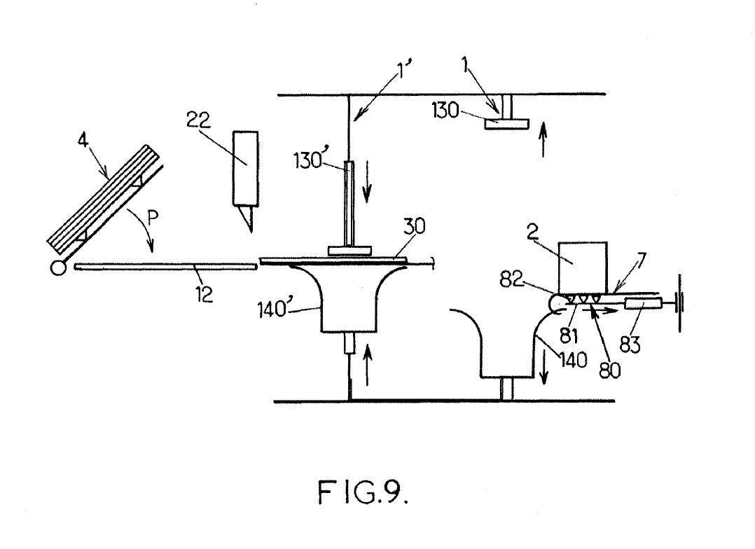

FIG. 9 illustrates the position of the tools of the two modules shown in FIGS. 6a and 6b, during a fourth step of the method of the invention;

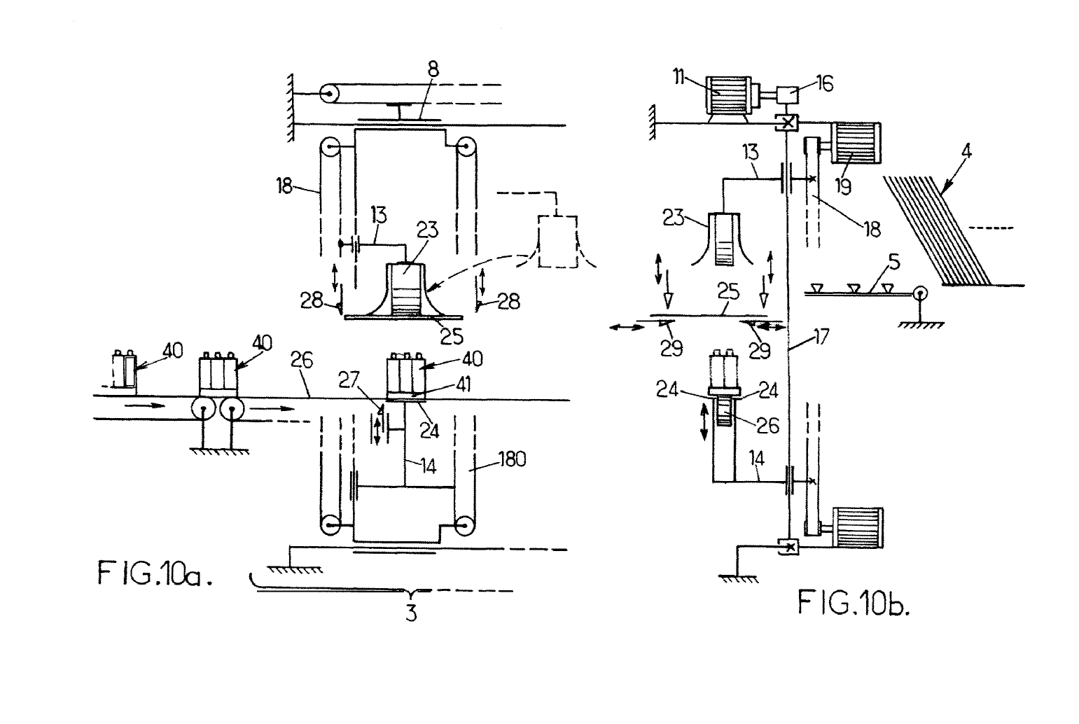

FIG. 10a shows a front view of another example of an installation equipped with a module according to the invention, arranged to perform a capping operation for a product lot arranged on a tray;

FIG. 10b shows the installation of FIG. 10a, viewed from the side;

FIG. 11 illustrates a variant for a first tool of the tool-holder module of the installation shown in FIGS. 10a and 10b;

FIG. 12 illustrates a variant for a second tool of the tool-holder module of the installation shown in FIGS. 10a and 10b;

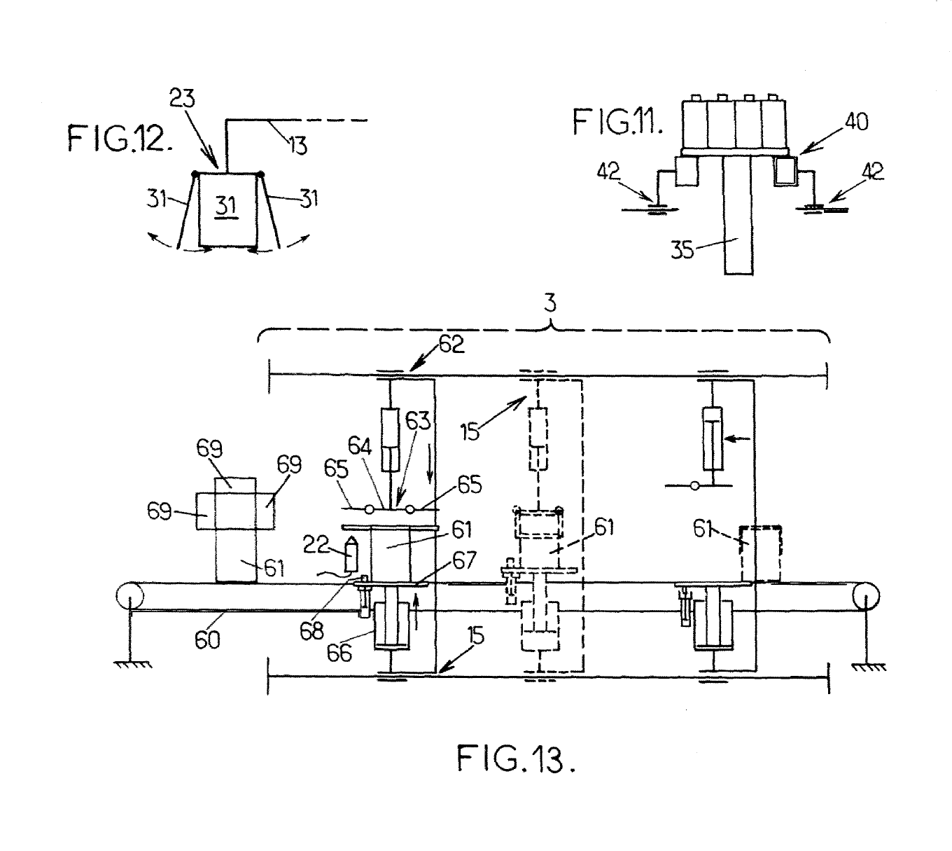

and FIG. 13 shows a front view of yet another example of an installation equipped with a module according to the invention, arranged to perform a box closure operation.

FIGS. 1a, 1b and 2 to 5 will first be discussed, in order to describe an installation of the invention comprising a single tool-holder module 1 for shaping at least one cardboard blank 2 in a shaping station 3.

In the following description, the terms “below,” “above,” “top,” “bottom,” “right,” and “left” are used in reference to the drawings to improve comprehension. They are not to be taken as limitations on the scope of the invention, particularly concerning the orientation of the shaping module 1 or of the cardboard blanks 2.

In fact, the orientation of the shaping module 1 and of the cardboard blank 2 is only presented here in the context of a preferred embodiment of the invention.

The shaping station 3 which carries the tool-holder module 1 according to the invention can be seen in FIG. 1a.

A magazine 4 of cardboard blanks 2 is located upstream from the shaping station 3, the cardboard blanks 2 all being positioned on their edge in the same direction, stacked one behind the other in the magazine 4.

The magazine 4 stores the cardboard blanks 2 in an angled position.

The installation comprises, in a known manner, means for extracting the cardboard blanks 2 one by one from the magazine 4, in particular using a cardboard blank 2 collection arm 5 which is mounted to swivel on a substantially horizontal axis Y. The arm 5 also comprises, in a known manner, suction cups 51 able to collect a blank 2 from the magazine 4 due to their suction effect.

The collection arm 5 brings the blanks 2 to a substantially horizontal position along an axis X represented in FIG. 1a.

This X axis, which is longitudinal, is also the axis along which the cardboard blanks 2 are advanced in the shaping station 3, between an entry position 6 and an exit position 7 (entry position 6 on the left of the shaping station and exit position 7 on the right of the shaping station).

The module 1 is mounted to travel between the entry position 6 of the shaping station 3 and the exit position 7 of the shaping station 3.

To do this, the module 1 comprises a movable framework in the form of a shaping trolley 8, carrying the shaping tools, and this module 1 also comprises means for moving said trolley 8 between the entry position 6 and the exit position 7.

These movement means are realized as substantially horizontal runners 9 on which the shaping trolley is mounted.

The runners 9 are arranged at the top and bottom of the shaping station, so as to guide the module 1 by its upper portion and its lower portion.

The means for moving the trolley 8 also comprise a belt 10, arranged for example in the upper portion of the shaping station 3. The belt 10 is connected to the trolley 8.

The belt is driven by an actuator 11 which, in the context of this example embodiment, is a servo-motor able to drive the belt in one direction and in the opposite direction. The actuator is illustrated in FIG. 1b.

The shaping station 3 comprises, at least at its entry 6, a set of rails 12 in a substantially horizontal orientation, at a predetermined height, on which the cardboard blanks 2 rest and are moved.

The rails 12 are spaced apart by a predetermined distance that is related to the width of the unshaped cardboard blanks 2, so that the unshaped blanks are able to rest on the two rails 12.

The exit position 7 may be equipped with such rails 12 or may comprise a conveyor and outfeed belt 200.

The shaping elements contained in the tool-holder module 1 will now be described.

According to the invention, the tool-holder module 1 contains a set of tool holders 13 and 14 which hold the shaping tools. The tool holders 13 and 14 are arranged on each side of the rails 12 on which the unshaped blanks lie, meaning that the tools 13 and 14 are positioned above and below the rails 12 in the context of this embodiment.

The module 1 also comprises means for moving each of the tool holders 13 and 14 on each side of a blank 2, in a direction perpendicular to the direction the blank travels, which is the direction Z shown in FIGS. 1a and 1b.

The tool holders 13 and 14 (and therefore the tools that they hold) are therefore moved in a vertical direction, between an inactive position 15 in which the tools are retracted and an active position 16 which is the “shaping position.”

The retracted position 15 of the tool holders 13 and 14 (and therefore of the tools) is the position in which said tool holders are the furthest from the rails 12 on which the unshaped blanks lie.

The shaping position 16 of the tool holders 13, 14 (and therefore of the tools) is the position in which the tool holders are closest to the rails 12 on which the blanks lie, as shown in FIG. 3.

The means for moving the tool holders 13, 14 between the shaping position 16 and the retracted position 15 are carried by the shaping trolley 8, to make the module as compact as possible.

The moving means comprise at least one runner 17 which is illustrated in FIGS. 1a and 1b.

The runner 17 is a vertical runner on which the tool holders 13 and 14 are mounted to allow them to move freely.

The tool holders 13, 14 are respectively connected to a belt 18 and 180.

Actuators 19 and 190 respectively drive the rotation of the belts 18 and 180 in one direction and in the reverse direction.

The actuators 19 and 190 are servo-motors in the context of this embodiment.

The rotation of the belts 18 and 180 in one direction and in the reverse direction causes the tool holders 13, 14 (and therefore the tools they hold) to be moved between the retracted position 15 and the shaping position 16.

It is arranged so that the shaping tools are removably assembled onto the tool holders 13 and 14.

In this manner, shaping tools of different forms can be used, depending on the shape to be given to the cardboard blank 2 (and in particular on how the method is to be applied, as will be described below).

In the embodiment illustrated in particular in FIGS. 2 to 5, the tools respectively consist of a punch 130 and a die 140 of complementary shape.

As can be seen in the figures, the punch 130 is in the shape of a disk with a certain thickness, and the die 140 is substantially bell-shaped, with the inner curve of the bell fitting against the outer edge of the disk.

The method for shaping a cardboard blank 2 between the entry position 6 of the shaping station 3 and the exit position 7 of the shaping station 3 will now be described.

According to the method of the invention, the travel of the cardboard blank 2 between the entry position 6 and the exit position 7 of the shaping station 3 is ensured by the shaping tools 130 and 140, at the same time as the cardboard blank 2 is being shaped by said tools 130 and 140.

The first step, illustrated in FIG. 2, shows that the tools 130 and 140 are in a retracted position 15 when a cardboard blank 2 is brought into position 6 at the entry to the shaping station 3, on the rails 12.

FIG. 3 illustrates the second step, in which the blank 2 is shaped.

In this step, the blank 2 is advanced on the rails 12 along the axis X by a pusher 20, up to a sensor 21 which detects the presence and the position of said blank.

At the same time, the tools 130 and 140 are brought into shaping position 16, meaning they are applied against the two opposite faces of the blank 2 resting on the rails 12.

To do this, the belts 18 and 180 are rotated by the actuators 19 and 190 (not represented in FIGS. 2 to 5).

In a third step illustrated in FIG. 4, the trolley 8 is moved horizontally, at the same time as the tools 130 and 140 are moved vertically.

This dual motion ensures the shaping of the blank as it is advanced in the shaping station 3.

Simultaneously, the pusher 20 which advanced the cardboard blank 2 is moved in the reverse direction, towards the magazine 4, in order to be positioned to take charge of a new cardboard blank 2 (FIG. 4).

The final step of the method according to the invention is illustrated in FIG. 5.

In this last step, the tools 130 and 140 are moved vertically to their retracted position 15, thus releasing the shaped cardboard blank 2 to an outfeed belt 200 located at the exit position 7.

The shaped cardboard blank 2 is then taken by this belt and carried to a station located downstream from the installation of the invention, such as a packing station for example.

In the example illustrated in FIG. 5, the tools 130 and 140 are moved to the retracted position 15 while the trolley 8 remains in place. This step occurs over a sufficient period of time to allow withdrawal from the blank, after which the tools 130 and 140 are moved to the retracted position 15, then the trolley 8 is moved to the entry position 6 of the shaping station 3.

To further increase the blank 2 shaping speeds, two tool-holder modules 1 and 1′ can be used, as illustrated in FIG. 6.

In the invention, each tool-holder module 1 and 1′ comprises at least one shaping trolley 8 carrying the shaping tools 130 and 140 (and analogously trolley 8′ and tools 130′ and 140′).

In the context of this embodiment, each shaping trolley 8 and 8′ of each module 1 and 1′ takes turns being in charge of the cardboard blanks 2 arriving at the entry position 6 of the shaping station.

The modules take their turns working with the blanks at regular intervals, to achieve optimum operation of the installation.

Because of the simultaneous and staggered operation of the two trolleys 8 and 8′, such an installation allows achieving speeds for shaped cardboard blanks 2 on the order of 50 items per minute.

This installation additionally comprises a device 80 which holds the shaped blank in place as the die and punch are retracted.

For clarity, the device 80 has not been represented in all the figures. However, it can easily be implemented by a person skilled in the art based on the information provided below.

Such an installation may also comprise, as illustrated in FIG. 6a, means 22 for applying glue to a portion of the cardboard blank 2, so that it is fixed in a certain position after shaping.

FIGS. 6a and 6b, as indicated above, are simply other views of the installation illustrated in FIG. 6, for better visualization of the arrangement of each of the modules 1 and 1′.

FIG. 6a shows the staggered operation of modules 1 and 1′.

In particular, one will note that the module 1 is located at the entry to the shaping station 3, with the tools 130 and 140 in the retracted position 15, while the module 1′ is at the exit position 7 of the shaping station with the tools 130′ and 140′ in the shaping position 16.

Thus, in the context of the embodiment illustrated, the modules 1 and 1′ are offset by half a shaping cycle in their shaping steps, with one of the module 1 beginning the shaping cycle while the other module 1′ is ending it.

FIG. 6b schematically illustrates what can be seen when looking at the installation from the extension of the outfeed belt located at the exit position 7, illustrated in FIG. 6a.

It should be noted that the means enabling the movement both of the shaping tools and of the trolleys 8 and 8′, are not implemented as systems of rails-belts-actuators, but as cylinder-driven systems that a person skilled in the art is able to assemble in their place.

One will therefore understand that the invention is not limited to specific means for moving the different elements of the shaping module 1, 1′, but instead it extends to the implementation of any equivalent means.

We will now focus on FIGS. 7 to 9, and describe the operation of the shaping method according to the invention which makes use of two shaping modules 1 and 1′.

In FIG. 7, one can see that the module 1 begins shaping a cardboard blank 2 by the translational vertical travel of the tools 130 and 140 into the shaping position 16. At the same time, the module 1′ releases a shaped blank 2′ by retracting the tools 130′ (punch) and 140′ (die) to the retracted position 15.

FIG. 8 shows a second step of this method making use of two modules 1 and 1′.

It shows that the module 1 moves and shapes the cardboard blank 2 by means of a vertical movement of the tools 130 (punch) and 140 (die) simultaneously to a horizontal movement of the module 1. During this time, the module 1′ is returned to the entry position 6 of the shaping station 3, the tools 130′ and 140′ being completely in the retracted position 15 when they reach the entry position 6. Also during this time, a new blank 30 is brought to the entry position 6 of the shaping station, after glue was applied using the gluing means 22.

FIG. 9 illustrates a final step in which the module 1 releases the shaped cardboard blank 2 in the vicinity of the exit position 7 of the shaping station 3.

At the same time, the module 1′ begins shaping the new blank 30, by moving the tools 130′ and 140′ to the shaping position 16. Also at the same time, a new blank is collected by the arm 5, then deposited on the rails 12, as is schematically illustrated in FIG. 9 by the collection arrow P, and so on.

To prevent the shaped blank 2 from being ejected from the system during retraction of the die, the device 80 is actuated. It will now be described.

The device 80 comprises a plate 81 equipped with suction cups 82.

The suction cups 82 use suction to hold the bottom of a shaped blank. They are therefore connected to sucking means, in a manner known to a person skilled in the art.

To allow placing the plate 81 under the shaped blank, as well as its retraction, the plate 81 is mounted at the end of a cylinder 83, and the assembly is mounted to allow vertical movement.

The cylinder 83 allows moving the plate 81 horizontally.

The vertical movement can be ensured by mounting the assembly onto a rail 84, connected to an electric cylinder, not represented.

To allow inserting the plate 81 in the die before retraction of the die and punch, the die comprises a passage opening (not represented) having dimensions which are substantially greater than those of the plate 81 equipped with suction cups 82.

The die also comprises a side vertical passage so that it can disengage from the device 80 when it moves vertically during retraction (see FIGS. 7 and 8 for example).

The vertical movement of the device 80 occurs when the shaped blank is completely disengaged from the die. In fact, when the blank is shaped, the holding device 80 brings the shaped blank to the outfeed belt at the exit position 7 of the station. Then the suction cups 82 are deactivated and the device 80 is lowered slightly in order to release the blank. Lastly, the plate 81 is retracted by actuating the cylinder 83, then is dropped down to a lower level.

The preceding description shows how the method of the invention allows shaping cardboard blanks in order to create boxes which can be packed in a station downstream, or to create cardboard displays (display trays) which are usually used in stores for displaying a series of products.

Other applications are also possible with the method and the module of the invention.

FIGS. 10a and 10b illustrate applying the method of the invention to the capping of item batches.

In FIG. 10a we find the installation described above for FIGS. 1a and 1b, comprising the magazine 4, the collection arm 5, the means 9 and 10 for horizontally moving the trolley 8, and the means 18 and 180 for vertically moving the shaping tools.

The shaping tools are different from those presented above. The tool located in the upper portion of the shaping station 3 is a bell-shaped crown 23, acting as a die installed on the tool holder 13. The lower shaping tool is installed on the tool holder 14 and consists of at least two pusher plates 24 which take charge of the product batches 40 to be capped by a cardboard blank 25 shaped directly onto the product batches 40.

The product batches 40 are realized from a set of products in adjacent rows in a tray 41. The product batches 40 are carried to the downstream end of the shaping station 3 on a conveyor 26.

The conveyor 26 extends for at least the length of the shaping station 3.

The batches 40 are advanced on the conveyor 26 until they reach a location determined by a reference system.

The reference system comprises: a pusher 27 for positioning a product batch 40, said pusher 27 being guided on the tool holder 14; and the positioning elements 28 provided on the tool holder 13 for indexing the position of the blank relative to the position of the product batch 40, before the module 1 shapes the blank directly onto the product batch 40, in particular in order to close it.

Gluing means (not represented) may also be provided, which allow applying glue to a specific portion of the cardboard blank 25 so that once the cardboard blank 25 is shaped, it is fixed to the tray 41.

To allow shaping the cardboard blank 25, this blank is guided in a horizontal passage by guide rails 29 (see FIG. 10b), until it is captured between the top of the product lot 40 and the end of the cap 23.

The guide rails 29 are arranged laterally relative to the horizontal passage for guiding the blank, and they support the lateral edges of said blanks during their conveyance to the reference system.

The rails 29 are retractably mounted on the sides of the passage (see arrows in FIG. 10b) to enable releasing the blank 25 when the shaping tools take charge of it.

To do this, the pusher plates 24 which support the product batch 40 to be capped are moved vertically upwards and moved horizontally until the upper portion of the batch 40 comes up against the cardboard blank 25 which itself is moving in a horizontal direction.

When the cardboard blank 25 is captured between the end of the cap 23 and the upper portion of the product batch 40, the guide rails 29 are retracted and the cardboard blank 25 is shaped onto the product batch 40.

Once the product batch 40 is completely covered by the shaped cardboard blank 25, the assembly is set down at the exit position 7 of the shaping station 3 by means of the pusher plates 24, which deposit the batch on the conveyor 26 as they descend, driven by the belt 18 that maneuvers the tool holder (see FIG. 10b).

Also note in FIG. 10b that the pusher plates 24 are formed by the ends of arms mounted on the runner 17.

However, it is possible to have another embodiment which provides an alternative to the two pusher plates 24 with a fixed spacing between them.

FIG. 11 shows a pusher plate 35 installed on the tool holder 14, and on which can rest a batch 40 of products packaged in a tray to be covered. The pusher plate 35 is designed to have a modifiable width, and the conveyors 36 are mounted to allow horizontal movement (schematically illustrated with the reference 42) such that the spacing between them can vary and can be set according to the width of the tray for the product batch 40.

It is also possible to design the crown 23 differently.

FIG. 12 illustrates a crown 23 in which the side portion is defined by wings (or flaps) 31 which are each hinged at their upper end (see arrow in FIG. 12).

FIG. 13 illustrates yet another mode for applying the method of the invention to the closing of boxes.

The installation in FIG. 13 comprises a conveyor 60 which advances boxes 61 having a fold-down lid, in the open position, at the entry 6 to the shaping station 3.

A module 62 according to the invention comprises a first shaping tool 63 (upper shaping tool) which is in the form of a central plate 64, above the conveyor 60.

The plate 64 has hinged flaps 65 on its sides.

Below the conveyor 60 is located the second shaping tool 66, which has a support plate 67 that takes charge of the box 61 when the box is precisely positioned against a positioning element 68.

This positioning element 68 also ensures the correct orientation of the box 61 relative to the plate 64 of the tool 63. In this manner, when the shaping tools move from their retracted position 15 to their shaping position 16, the plate 64 presses against the upper surface of the box 61 and the hinged flaps 65 ensure correct folding of the folding parts 69 of the cover on the side faces of the box 61.

Glue is applied beforehand, within the vicinity of the entry position 6 of the shaping station 3, to the folding parts 69 of the cover of the box 61 in order to hold them in place.

To convert the lid of the box 61 from its open position (it is in this state when it enters the installation) to a closed position, before the parts 69 are folded, there can be a transverse lateral movement of the module 62, or of at least the shaping tool 63. The plate 64 and flaps 65 could thus fold the cover before the flaps 65 are actuated to fold the parts 69 against the side faces of the box 61.

From the above description, one can understand how the invention allows shaping different cardboard blanks, in particular because of the means used for changing the shaping tools on the shaping module.

One can also understand how the method of the invention allows achieving higher production rates than those that can be obtained by current devices, in particular by shaping the blank while it is moved. Specifically, one can see how the current speed can be doubled because of the use of two modules according to the invention.

It is understood that the invention is not limited to the embodiments described above, however.

In particular, it is easily understood how the implementation of the means for moving the module on its rails, or even of the tools, could be different without leaving the scope of the invention.

For example, it can be seen in FIG. 13 that such means can be achieved by cylinders or by systems of runners.

The invention is therefore not limited to the embodiments cited above, but extends to the implementation of any equivalent means.

1-18. (canceled)

19. A Method for shaping at least one cardboard blank between an entry position and an exit position of a shaping station, said method including a step of using shaping tools on said cardboard blank, said shaping tools moving reciprocatingly on each side of said blank between a shaping position and a retracted position,
said method comprising ensuring the movement of the cardboard blank by means of said shaping tools between said entry position and said exit position of the shaping station while the cardboard blank is being shaped by said shaping tools,
said shaping method making use, within said shaping station, of two tool-holder modules,
wherein each tool-holder module comprises a shaping trolley mounted to move reciprocatingly on substantially horizontal runners,
each of the runners being in the form of a straight line segment,
each module carrying a die and a punch which constitute the shaping tools,
said shaping tools moving in a vertical direction,
each shaping trolley of each module taking turns being in charge of the cardboard blanks arriving at the entry position of said shaping station.

20. The shaping method according to claim 19, wherein said shaping trolleys of said two modules take turns, at regular intervals, at being in charge of the blanks.

21. The shaping method according to claim 19, comprising a step of applying glue to at least a portion of a cardboard blank before said cardboard blank is shaped.

22. An application of the method according to claim 19, in order to create cardboard displays.

23. An application of the method according to claim 19 in order to create cardboard boxes.

24. An application of the method according to claim 19 in order to create batches of items.

25. An application of the method according to claim 19 to the closing of boxes.

26. A tool-holder module for shaping at least one cardboard blank in a shaping station, in order to implement the method according to claim 19, said tool-holder module comprising:
at least one set of shaping tools,
means for moving each of said tools in a vertical direction, on each side of a cardboard blank, between a shaping position and a retracted position;
means for applying pressure by at least one of said tools against a face of said blank;
said tool-holder comprising a shaping trolley, carrying said tools,
said set of tools including a die and a punch;
said module comprising runners in the form of a straight line segment ensuring a horizontal reciprocating movement of said shaping trolley between an entry position where said blank enters said shaping station and an exit position where the shaped blank leaves said shaping station.

27. The tool-holder module according to claim 26, wherein the means for moving said trolley on the runners comprise a belt, connected to the shaping trolley, and an actuator able to drive the belt in one direction and in the reverse direction.

28. The tool-holder module according to claim 26, wherein the means for moving the tools in a vertical direction between the shaping position and the retracted position are carried by the shaping trolley and comprise:
at least one runner on which tool holders are movably mounted, each of the tools being mounted on a tool holder and each of the tool holders being connected to a belt, and
a. an actuator to drive each belt in one direction and in the reverse direction.

29. The tool-holder module according to claim 28, wherein each of the tools is removably mounted on said tool holder to which is it connected.

30. The tool-holder module according to claim 26, wherein said tools comprise a die comprising a central plate and at least one hinged flap, for performing a capping and/or folding operation.

31. The tool-holder module according claim 26, wherein it comprises holding means for maintaining a blank in place after shaping and before retraction of said shaping tools.

32. The tool-holder module according to claim 31, wherein said holding means comprise a device equipped with a plate having suction cups able to hold a bottom of a shaped blank in place with suction, the device being movably mounted to travel between a position where it holds the blank in place before retraction of the shaping tools and a position where it is retracted to allow removal of the blank.

33. The tool-holder module according to claim 31, wherein at least one of said shaping tools comprises means for accommodating and accepting said holding means.

34. The tool-holder Module according to claim 26, wherein it comprises means for moving at least one of said shaping tools transverse to a direction of movement of the blanks during their shaping.

35. An installation comprising two tool-holder modules according to claim 26, and means for using said two tool-holder modules in alternation.

36. The installation according to claim 35, wherein it comprises means for bringing blanks to said entry position of said shaping station and means for taking charge of the shaped blanks at said exit position where they leave said shaping station.
